(19) United States
(12) Patent Application Publication
(10) Pub. No.: US 2010/0049602 A1
(43) Pub. Date: Feb. 25, 2010

(54) Systems and Methods for Measuring the Effectiveness of Advertising

(76) Inventor: William R. Softky, Menlo Park, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 12/368,288

(22) Filed: Feb. 9, 2009

Related U.S. Application Data
(60) Provisional application No. 61/026,937, filed on Feb. 7, 2008.

(51) Int. Cl. G06Q 10/00; G06Q 30/00

(52) U.S. Cl. 705/14.45

(57) ABSTRACT

A system and computer based method are provided for measuring the effectiveness of advertisements. The systems may include a first networked server providing an ad associated with an advertiser at random times over a limited period of time, where the networked server logs in a database when the ad is served to an ad-viewer, a display connected to a client computer presenting the ad, a second networked server measuring the customer response after providing the ad and storing the customer response and a time of response in a second database, and a computer application program for performing cross-correlations across the first database and the second database to determine the correlation of consumer response to the ad.

### RELATED APPLICATIONS

The present application claims priority from U.S. Provisional Application Ser. No. 61/026,937 filed Feb. 7, 2008, which is incorporated herein by reference in its entirety for all purposes.

### FIELD

The present invention relates generally to the field of advertising. More specifically, embodiments of the present invention relate to improved systems and methods for measuring the effectiveness of advertisements including computer-based systems.

### BACKGROUND

One of the challenges in advertising is measuring whether it works. To measure the effectiveness of a campaign, an advertiser would like to know the effect of the ads upon user behavior. This is essentially a problem in signal-processing: how to infer a causal relationship between two separate signals, the “advertising” signal, and the “user behavior” signal.

Technology has made it both easier to turn on and off advertisements and easier to measure their results. For example electronic signboards can show rotations of many ads per minute, and can in principle modulate and record the exact times each ad was shown; internet ads can be served at specific times to specific regions and user-profiles; non-broadcast media (like cable TV) can choose which ads to show to which consumers at which time; these all comprise the “advertising signal” aimed at consumers. Likewise, electronic databases can record the “consumer responses,” including the many consumer transactions such as time and location of each product's sale, each incoming phone call, and each visit to a website.

In order to have the greatest influence on sales or reputation, an advertising campaign typically has as long a duration as possible, as wide a geographical reach as possible, and as regular an exposure as possible. Paradoxically, those features make it more difficult to tell whether the campaign had the desired effect. In web advertising, this is embodied in the cost-per-impression (CPM) advertising model, which generates a dollar amount for one thousand ads shown on a web site, but which has no effectiveness measure.

The “click-through” is a paradigm in online internet advertising measurement. It is a mechanism by which consumers can react immediately to advertising messages put in front of them. This feature has given rise, however, to the idea that all online ads should aspire to drive users to click on them, and that clicking on them is the basic means of measuring their effectiveness.

However, internet advertising, as well as advertising in all media, is built on a basic contradiction: advertisers want to measure their reach, but any actual measurement leaves out the large-but-intangible “branding” aspect of a campaign. The principal aim of many branding campaigns, however, needs not necessarily to be driving clicks. It can instead influence attitudes about brand attributes and stimulate purchase intent. Furthermore, even when an objective of the ad is to drive people back to the advertiser's website, an immediate click is not always how they get there. In many cases, people exposed to ads do not click immediately, but they end up visiting those websites later of their own accord, taking the desired action promoted in the ad in response to a web-search or by clicking on a subsequent ad.

Based on current methods of measuring the effectiveness of online ads, advertisers want to measure influence, but can only actually measure actions. Many advertisers track “view-throughs” (like click-throughs, but measuring all visits, not just ad-click visits), but still have questions about what percent of those visits should be credited to the ad exposure (as opposed to mere coincidence). After all, an ad campaign may run in multiple channels; maybe it was the TV ad which caught the attention of a visitor in question, prompting her to visit the website, and not the online ad. Or perhaps she was already a loyal customer of the company and had planned to drop by the site, independently of the ad. Therefore, it is generally difficult to determine whether the online ad had the desired effect.

The need for measurement drove the explosion of cost-per-click (CPC) advertising over a decade ago in the 1990s, because a click is at least a clear indication that the ad had some level of impact even though CPC advertising did not measure the vast majority of unclicked ad-views. Likewise, cost-per-action (CPA) advertising is an even more specific measure of effectiveness, but it leaves out the impact of both ad-views and clicks. CPC and CPA advertising are convenient methods of measurement, but do not accurately reflect the effectiveness of an online ad or ad campaign.

Advertisers of all media, including web advertising, need to know the effect of the ads upon all aspects of user behavior, particularly the consumer response. More specifically for online advertising, web advertisers need a measure of brand-recognition or user behavior which transcends whether a given user clicks on a specific ad the moment he sees it. As such, it is desirable to provide the online advertising industry a way of measuring the more intangible, non-click impacts of online ad-views. Furthermore. it is also desirable to provide the advertising industry in general a way of measuring the intangible effect of advertisements.

The basic concept of correlating ad-views with subsequent site-visits has been outlined in research papers by Atlas Solutions (see http://www.atlassolutions.com/institute_marketinginsights.aspx, “The Combined Impact of Search and Display Advertising,” and “Overlap's Impact on Reach, Frequency, and Conversions”). Atlas Solutions, however, does not provide the novel systems and methods described in the embodiments of the invention disclosed herein to measure the effectiveness of an advertising campaign.

### SUMMARY

In accordance with a preferred embodiment of the present invention, a system for measuring the effectiveness of online advertising including: a first networked server providing to one or more web pages an online ad associated with an advertiser's web page, wherein said first networked server logs in a first database that said online ad is served to an ad-viewing user; a display connected to a client computer presenting said one or more web pages and said online ad to said ad-viewing user; a second networked server identifying a visitor of said advertiser's web page, wherein said second network server identifies and logs in a second database said visitor of said advertiser's web page; and a computer application program performing cross-correlations across said first database and said second database to determine whether said ad-viewing user is the same as said visitor, said computer application program analyzing data from the cross-correlations to provide a statistical measure of visitors of said advertiser's web page credited to said online ad.

In accordance with a preferred embodiment of the present invention, a computer-based method for measuring the effectiveness of online advertising including: presenting an online ad associated with an advertiser's web page to an ad-viewing user; providing an identification for said ad-viewing user; logging to a first log said identification for said ad-viewing user and that said online ad is served to said ad-viewing user; providing an identification of a visitor to said advertiser's web page; logging to a second log said identification for said visitor and that said visitor visited said advertiser's web page; performing cross-correlations between said first log and said second log to determine whether said ad-viewing user is the same as said visitor; and analyzing said cross-correlations to provide a statistical measure of visitors of said advertiser's web page credited to said online ad.

In accordance with a preferred embodiment of the present invention, a system for measuring the effectiveness of advertising including: a first networked server providing an ad associated with an advertiser at random times over a limited period of time, wherein said first networked server logs in a first database when said ad is served to an ad-viewer; a display connected to a client computer presenting said ad to said ad-viewer; a second networked server measuring customer response after providing said ad and storing said customer response and a time of said customer response in a second database; and a computer application program performing cross-correlations across said first database and said second database to determine the correlation of consumer response to the ad.

In accordance with a preferred embodiment of the present invention, a computer-based method for measuring the effectiveness of advertising including: presenting an ad associated with an advertiser to an ad-viewer at random times over a limited period of time; providing an identification for said ad-viewing user; logging to a first log that said ad is served to said ad-viewer; logging to a first log when said ad is served to said ad-viewer; logging to a second log a customer response after providing said ad; logging to a second log when said customer response occurs; performing cross-correlations between said first log and said second log to determine the correlation of consumer response to the ad.

Other and further features and advantages of the present invention will be apparent from the following descriptions of the various embodiments. It will be understood by one of ordinary skill in the art that the following embodiments are provided for illustrative and exemplary purposes only, and that numerous combinations and modification of the elements of the various embodiments of the present invention are possible.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of embodiments of the present invention, reference is made to the following Detailed Description, which is to be read in association with the accompanying drawings, wherein:

FIG. 1A is a diagram illustrating a correlation between user clicks and webpages;

FIG. 1B is a diagram depicting the correlation between induced visit user clicks and web pages;

FIG. 2 is a chart illustrating an embodiment of a cross-correlation;

FIG. 3 illustrates one embodiment of a direct cross-correlation graph compiled using the data logged by the ad servers;

FIG. 4 illustrates another embodiment of a direct cross-correlation graph compiled using the data logged by the ad servers;

FIG. 5 is a flowchart illustrating an embodiment of a process of generating a direct cross-correlation graph.

### DETAILED DESCRIPTION OF EMBODIMENTS

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. Accordingly, the present invention may take the form of an entirely hardware embodiment, an entirely software embodiment or an embodiment combining software and hardware aspects. Moreover, the embodiments should not be interpreted as limited to web-based applications, such is merely provided for ease of understanding. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Aspects of embodiments of the present invention may be implemented in all form of advertising across all media types, including, but not limited to, traditional media such as newsprint, magazine ads, cable television and broadcast advertising, as well as electronic media such as web advertising, electronic signboards, e-mail and cell phone messages, and interactive online media.

Aspects of embodiments of the present invention may also be implemented on one or more computers executing software instructions. According to one embodiment of the present invention, server and client computer systems transmit and receive data over a computer network or a fiber or copper-based telecommunications network. The steps of presenting an ad, providing identifications, logging identifications and times of actions and responses, performing cross-correlations; and analyzing the cross-correlations, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instruction over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or client computers. In some instances, client and server functionality may be implemented on a single computer platform.

Embodiments of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “network” and “online” may be used interchangeably and do not imply a particular network embodiment or topography. In general, any type of network (e.g., LAN, WAN, or Internet) may be used to implement the online or computer networked implementation of the content rewarding system.

In one embodiment of the present invention, the systems and methods used to measure the effectiveness of advertising can be utilized to monetize the advertisements. The novel concept behind one embodiment of the present invention is that of “induced visits”: a measure of the statistical increase in visits as induced by ad-views (indirect or delayed ad-clicks). The induced visits include not only the immediate visits from the ad directly to the site (typical ad-clicks), but also any visits correlated with any ad to any part of the site at any time subsequently. For example, a networked server or client computer keep tracks of which users have seen which ads, and subsequently keeps track of which of those users' later visits to the site are associated with those ads. Of course, there are a certain percentage of users who would have, purely by chance or coincidence, visited the site regardless of the ad-view. Because this may affect the measurement of the effectiveness of the ad, a comprehensive statistical analysis is utilized to insure the accuracy of any correlation analysis.

In another embodiment, the consumer response to an advertisement is measured. The consumer response is a measurement of something of interest to the advertiser including but not limited to actual store or website visits, purchases, or referrals. The consumer response is a data stream that is logged over a limited period of time. The limited period of time could be a number of hours, days, weeks, months or any measurable period of time. The limited period of time could also include the time until a specified number of ad views are completed. In general, the limited period of time could be any measurement of time regardless of the way the measurement is determined. Furthermore, the limited period of time may be adjusted such that it is increased or decreased. For example, there may be a reason to look at only a sub-period of time (i.e., the time surrounding a holiday) or the ad may experience a fault (i.e., the billboard or website going down) and therefore less than an entire time period is representative of the data that is desired by the advertiser.

The data stream is a measurement of advertising output (i.e., time stamps of the minutes on which the ad first appeared, the minutes or seconds when ad was visible, time at which the advertisement ran, the cumulative number of ads visible at any minute of time nationwide, the sum total of advertising minutes, or displays, or any other measurement of data output form the advertisement.). The data stream represents a number which corresponds to the intensity of the available advertising signal.

The data stream of a customer response, for example an aggregate of weighted responses, a list of the time which the ad is viewed, list of time products were purchased, the call ins or visits to a store or site, the response of consumers on a phone or in a store or even the absence of consumers, may be accumulated over a period of time or across users, geographic regions, demographics or any other means of grouping, The data stream could also be aggregated by revenue over a period of time, or a period of time to generate a certain revenue level or site visits or any combination thereof.

In the advertising industry, there is a metric sometimes referenced as a view-through. A view-through uses a data stream of when the advertisement is presented and when viewers respond. However, current techniques account for every viewer who ever visits after seeing an ad. Embodiments of the present invention provide novel techniques for measuring, calculating and removing from the analysis those consumers or viewers who would have visited the advertiser whether or not the consumer saw the ad. As detailed in an embodiment herein, one such novel technique is to perform a demographic hold out—not showing the add to one of two identical demographic users and subsequently measuring and analyzing how those not exposed respond.

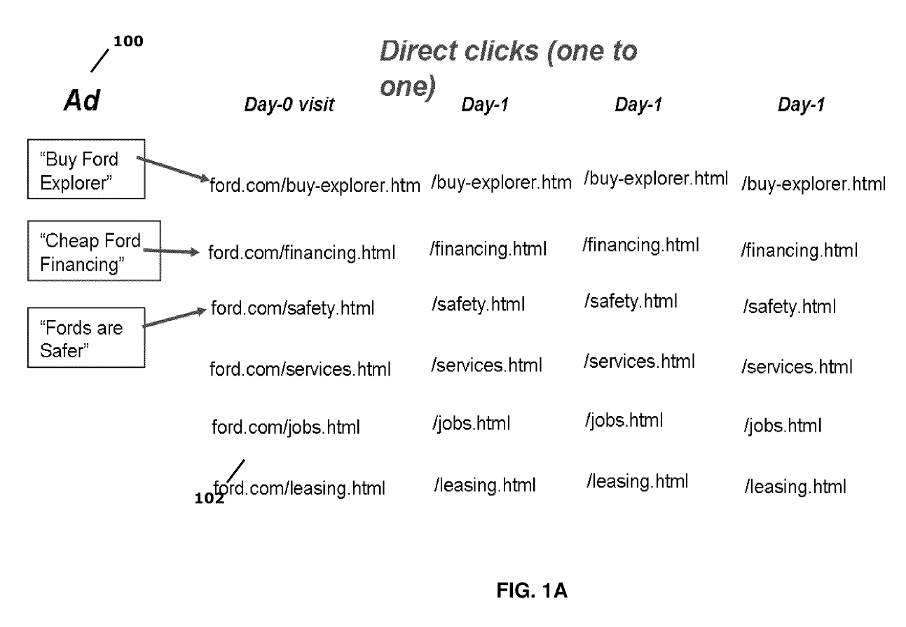

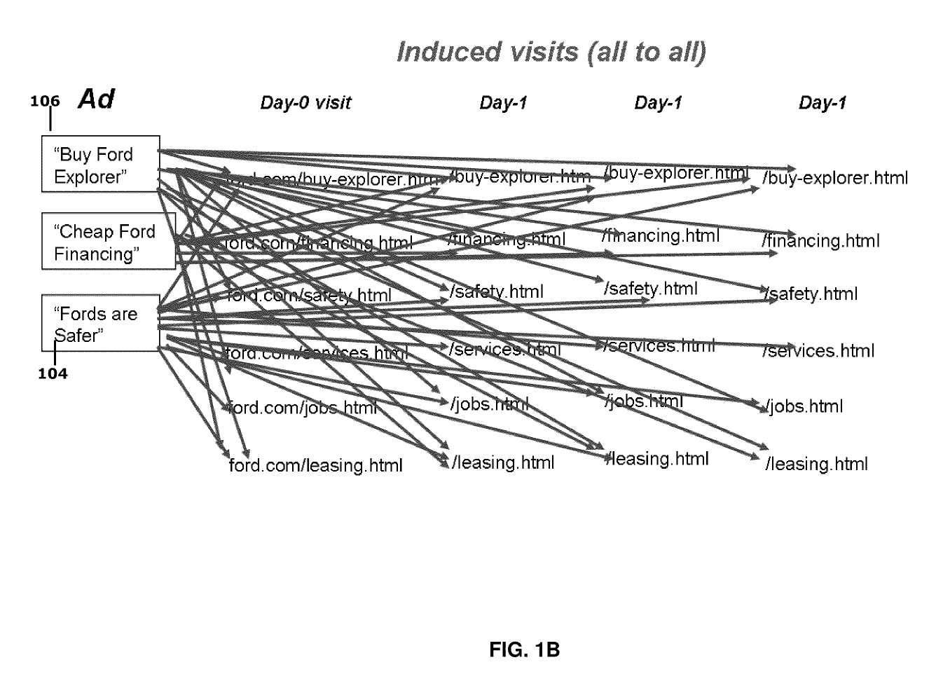

FIG. 1 includes diagrams illustrating the difference between measuring the impact of direct clicks versus those of induced visits. In FIG. 1A, the diagram illustrates that each ad 100 and any subsequent user click is correlated to exactly one web page 102. In a direct click measurement model, the effectiveness and monetization of the ad is only calculated based on a user's clicking on, for example, “Cheap Ford Financing” ad, which takes the user directly to the corresponding web page for Ford financing at the time of the ad-view. In FIG. 1B, the diagram illustrates that the effects of branding and induced visits should also be calculated when measuring the effectiveness of the ad. Each ad may result in an induced visit to any or all of the target web pages of the advertiser's web site, even at a later time. For example, when a user is presented with an ad for “Fords are Safer,” 104 a subsequent visit to the web page corresponding to “Buy Ford Explorer” 106 should also be calculated when measuring ad effectiveness for the monetization of the advertisement.

In one embodiment of the present invention, measuring induced visits utilizes pervasive cookies, JavaScript, powerful computer databases, and other data collection and tracking mechanisms in addition to the correlations described in the embodiments of the present invention. These computer software tools, techniques and computer hardware are typically implemented in the web advertising measurements. For example, advertisers can track induced visits easily using cookies and match-back JavaScript pixels on the advertiser's site. A cookie can be placed on a client computer when an ad is shown to a user, and tracked by an ad serving log. When a user exposed to an ad in a campaign shows up at the advertiser's site, the match-back pixel will recognize the exposed cookie. Ad serving logs can then identify whether the person came directly via a click or later on their own. As a result of the novel techniques of the correlations described herein, a measurement of the ad-related visits in a campaign can be directly attributed to the induced visit effect as opposed to direct clicks.

In one embodiment of the present invention, the measurement of ad effectiveness is based on the construction of a direct cross-correlation graph. The technique of cross-correlation is a method for inferring causation from correlation. This technique is used frequently in neurobiology to infer the effect of one neuron's firing on another neuron's firing. Cross-correlation takes two streams of events and creates a graph from which one can measure whether events in the two streams are related, and if so, whether one type of event occurs first or whether the events tend to occur at the same time or whether the order is random.

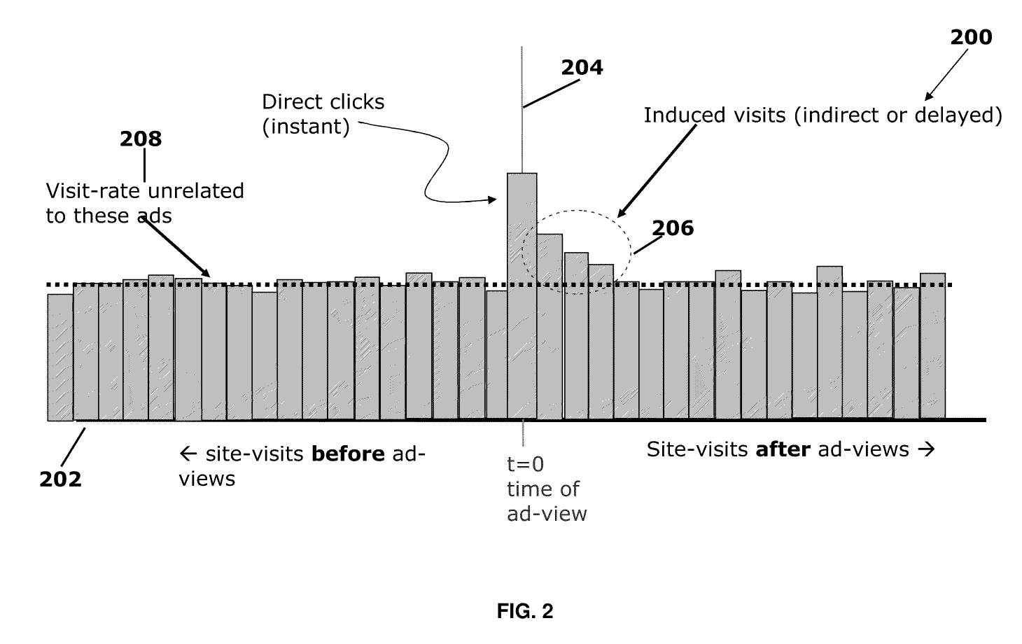

FIG. 2 is a chart 200 illustrating an exemplary cross-correlation graph output as a result of the analysis of visits to the advertiser's web site. The vertical axis 202 represents site-visits, and the horizontal axis 204 represents time before and after each ad-view, with t=0 as the time of the ad-view.

The graph illustrates a measurement of the effectiveness of the advertisement based on an induced visit resulting from an ad-view. The values to the left of the vertical line at t=0 represent the total number of site-visits preceding ad-views. The values to the right represent site-visits following ad-views. The horizontal dashed line represents the average visit-rate on the left of t=0 (i.e. site-visits which, preceding ad-views, were not caused by the ad-views). The bars represent the number of visits over time. Therefore, as is the case in this embodiment, visits to the right of t=0 and above the horizontal dashed line represent exactly the additional site-visits induced by the ads themselves, as denoted by the dashed circle 206. By definition, any direct clicks are included in the spike at t=0, because such occur immediately.

Utilizing this novel system and method in accordance to one embodiment of the present invention, this direct cross-correlation graph avoids problems with site-visits not caused by the ads of interest, and by ads which do not cause site-visits 208. Ads which do not cause site-visits merely leave the background or baseline level of site-visits unchanged. These ads do not effect the direct cross-correlation graph, and thus, do not have any peak following t=0. Also, additional site-visits caused by other reasons (such as search engines, bookmarks, or clicks on other ads) will merely raise the baseline at left (i.e. the dashed line), also shifting the peak upward but not making it extend any farther above that baseline.

One skilled in the art will recognize that standard statistical techniques, including but not limited to T-tests and standard deviations, may reveal whether the spike-above-baseline reaches statistical significance. Other statistical techniques that may be used include but are not limited to analysis of variance, the chi-square test, factor analysis, Mann-Whitney U, Mean Square Weighted Deviation, Pearson product-moment correlation coefficient, regression analysis, and time series analysis. Embodiments rely on implementing statistical analysis of the data. Such analysis includes but is not limited to the process of examining data to draw conclusions or insights, and determine cause-and-effect patterns between events; a non-limiting example is the use of algorithms for estimating the incremental boost in customer response due to the ads. Using statistical analysis, the systems and methods herein provide novel approaches to measure the baseline of consumer actions or choices by analyzing what would have happened randomly even absent the advertisement.

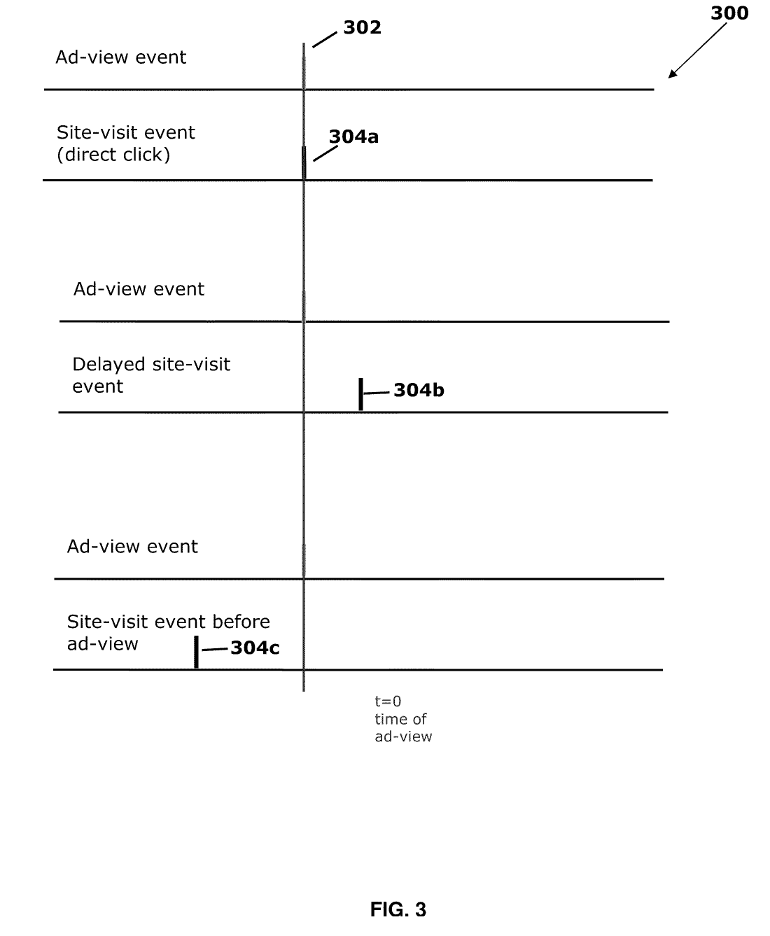

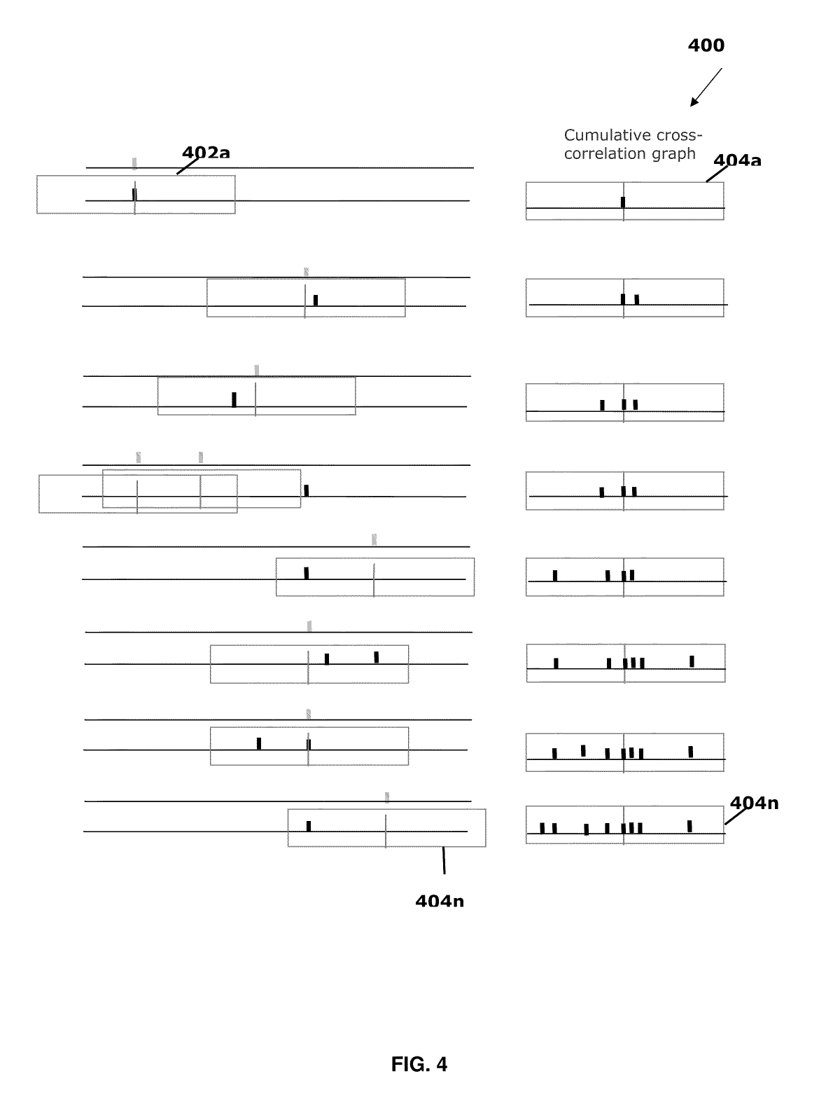

FIGS. 3 and 4 are diagrams illustrating how the direct cross-correlation graph is compiled using the data logged by the ad servers. The graph is based on the ad-view and site-visit streams for a multitude of users. In FIG. 3, as an illustration of the input of data, three examples are shown of how different situations are accounted for in the graph 300. The vertical line represents t=0 302, the time of the ad view event. The dark bars represent the time at which a site-visit event occurs 304 a, b, c. If the site-visit event is a result of a direct click, the event is accounted for with a dark bar at time t=0 304a. If the site-visit event is delayed after the ad-view, the event is accounted for with a dark bar at the right of t=0, 304b at some time where t>0. If the site-visit event precedes the ad-view, the event is accounted for with a dark bar at the left of t=0, 304c at some time where t<0. Charting data like this on a cross-correlation chart for a multitude users, ad view events, and site-visits, the novel measurement of ad effectiveness method disclosed herein can be accomplished.

In FIG. 4, by utilizing the system and method of one embodiment of the present invention, the site-view sets of events are charted and used to process a summation of the ad-view stream for the same user 400. Each pair as shown on the left of FIG. 4 (light bars for ad-views and dark bars for site-visits), represents the ad-view stream for a single user, i.e., 402 (a.n). A box is centered horizontally (at “t=0”), and only site-visits within this box are counted for in the summation. On the right side of FIG. 4 is a cumulative graph, which accumulates the site-visits for each user 404 (a.n). As the cumulative graph on the right fills up based on the user data, it should resemble, for example, FIG. 2 described above.

Mathematically, the ad-views, site-visits, and the final graph can be represented as a set of events, for example, as a set of times like [T1, T2, T3, . . . ]. Ad-views may be labeled as [Ta1, Ta2, Ta3, . . . ] and site-visits as [Ts1, Ts2, Ts3, . . . ]. The final set of cross-correlation events is defined as the time-differences between each combination of site-visit and ad-view, mathematically shown as follows:

[Ts1-Ta1, Ts1-Ta2, Ts1-Ta3, . . .

. . . Ts2-Ta1, Ts2-Ta2, Ts2-Ta3, . . .

. . . Ts3-Ta1, Ts3-Ta2, Ts3-Ta3, . . . }

It is a histogram of these events (the original graph) which shows the statistical influence of ad-views on site-visits.

In one embodiment of the present invention, a demographic control-group calculation can be performed. Control groups are important to the “scientific method.” In such an embodiment, to determine whether a particular factor is causing an effect, namely measuring the effectiveness of web advertising, users are separated into two observed groups: one that has viewed ads related to the target site, and another otherwise identical group that has not viewed ads. It is important that both groups are demographically identical, in particular that if the ads are targeted by viewer demography or geography then the non-viewer group should have the same characteristics as the viewer group, perhaps by deliberately not showing ads to eligible viewers in order to create the non-viewer group. In this embodiment, by comparing the rate at which ad-viewers and non-ad-viewers visit the site, it can be inferred how many visits were induced by the ads themselves. This method analyzes cases in which a site-visit followed an ad, and does not require the target site to place a “cookie” identifying the user. However, it does require that the target site recognize and record a cookie placed by the ad).

An example of the resulting demographic control-group calculation for “Ford” ads is shown in Table 1 below:

TABLE 1

| | | | “Ford” pages | | |
|---|---|---|---|---|---|
| | | | visited w/in one | | INDUCED VISITS = |
| | | | month of ad | Rate of visit | impressions * |
| Demographic | Impressions | Clicks | (excluding clicks) | following view | excess rate |
| “Ford” ad- | 1,000,000 | 10,000 | 40,000 | 40,000/1,000,000 = | |
| views by target | | (1% CTR) | | 4% | |
| users | | | | | |
| non-Ford ad- | 500,000 | 0 | 6,000 | 6,000/500,000 = | |
| views by | | | | 1.2% | |
| same user | | | | | |
| demographic | | | | | |
| Excess | | | | 4% − 1.2% = 2.8% | 1,000,000 * 2.8% = |
| | | | | | 28,000 |

The final number in the lower right represents the number of extra site-visits that can be attributed to the ad-view, based on the aggregate correlations. In this example, there are almost three times as many induced visits (28,000) as direct clicks (10,000).

One novel feature of embodiments of the present invention is that the “induced visits” can be monetized in the same manner as clicks—merely billed as “price per extra visit” rather than “price per click”—as a tangible but much broader measurement of impact on the viewer. Furthermore, an additional important feature of this novel system and method is that the graphs and calculations are simple enough that they can be understood by the advertising customers as a basis of trust, and adopted in the marketplace as a clear standard of performance when measuring the effectiveness of ads.

In another embodiment of the present invention, advertising signals are presented in random “bursts,” and subsequently, cross-correlated with the consumer results signals with it. Advertising randomly appears counter-intuitive, but with ads that are shown randomly (or pseudo-randomly), any correlation of consumer results with that signal is directly attributed to the ads rather than to an external effect like seasonality.

In this embodiment of the present invention, the period of time T (the duration of a burst's influence on a user) must be reasonably short; measurement is most effective as each burst of advertising is likely to affect users only over a limited period of time T, after which that burst's effectiveness has waned. Then, if the ad-bursts are on average spaced farther apart than T, a slight but temporary upsurge in user response will appear on average after each ad-burst presentation, and aggregating the responses according to the time after the previous presentation will allow the collective affect to be measured. Therefore time T must be limited. For example, in an optimal, but not limiting, case, a time-limited ad is presented, with a specific offer which expires in an hour. Ads could be presented several times a day, and in measuring the effectiveness of the ad, the number of responses in the hour immediately after an ad can be compared with the number of responses in the other hours of the day.

In one embodiment of the present invention, the system and method may be implemented by logging and tracking the (random) times at which an electronic billboard displays an ad, and correlating these times when ads were presented with the total of nearby store visits, internet hits, and phone calls against the display times. Similarly embodiments of the present invention are applicable to random television spot ads, radio ads, newspaper or other print advertisements, including signs in transportation centers, i.e., airports, bus depots.

In one embodiment of the present invention, the system and method may be implemented by running a television or radio ad at random times, and subsequently, correlating the times when ads were presented against that time-signal the aggregated store visits, internet hits and phone responses occurred.

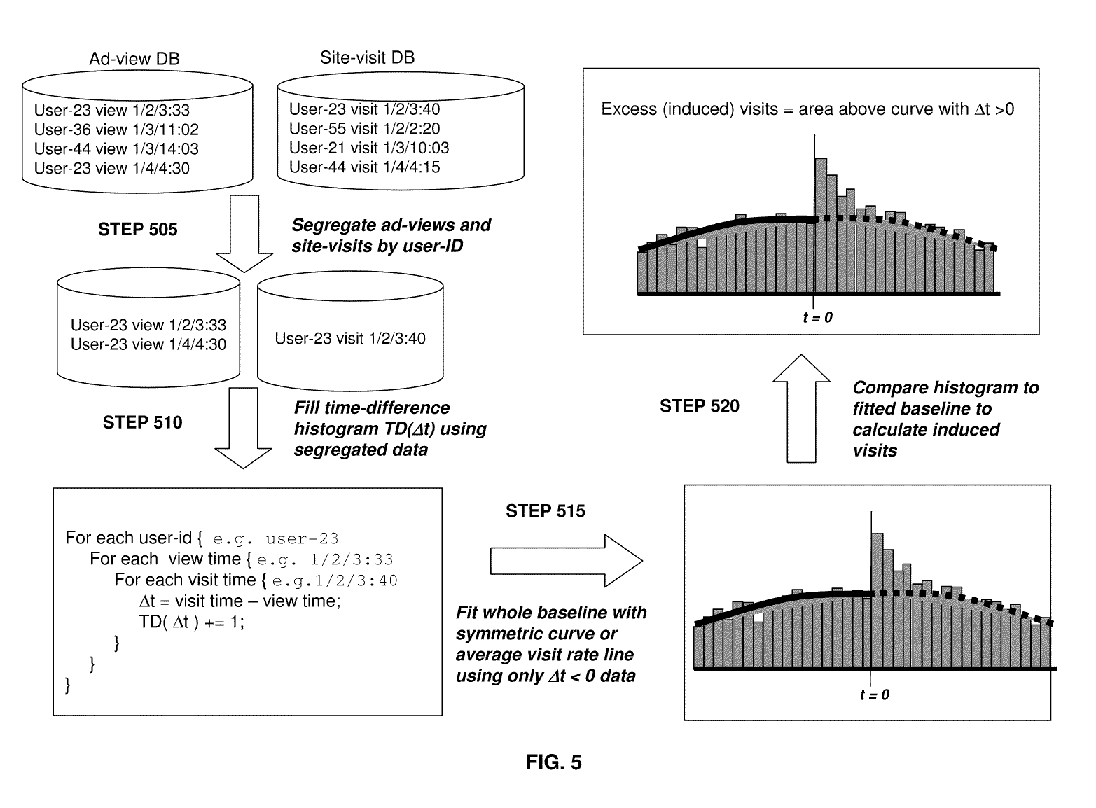

FIG. 5 is a flowchart which describes a process of generating a direct cross-correlation graph in accordance to one embodiment of the invention. In step 505, utilizing the data collected from the ad-view database (“ad-view DB”) and the site-visit database (“site-visit DB”), the ad-views and site-visits are segregated by identification of the user or visitor (e.g., a user identification or user ID). At step 510, a time-difference histogram of tabulated frequencies of visits by a user over time (or “TD(Δt)”) is filled in with the data segregated by user ID. At step 515, the baseline of the histogram is fitted with a symmetric curve or average visit rate line using only Δt<0 data (i.e. site-visits preceding ad-views which were not caused by the ad-views). In step 520, the histogram and fitted baseline are compared to calculate the number of induced visits. Therefore, in the exemplary histogram as shown in FIG. 5, visits to the right of t=0 and above the symmetric dashed line represent exactly the additional site-visits induced by the ads themselves, as denoted by the circled area.

As noted previously the forgoing descriptions of the specific embodiments are presented for purposes of illustration and description. They are not intended to be exhaustive or to limit the invention to the precise forms disclosed and obviously many modifications and variations are possible in view of the above teachings. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims and their equivalents.

1. A method for measuring the effectiveness of advertising, said method comprising:
measuring a presentation of an advertisement;
measuring a customer response;
performing a cross correlation between said presentation and said consumer response;
determining a baseline consumer response as a result of said cross correlation.

2. The method of claim 1, wherein said presentation of an advertisement comprises multiple advertisements.

3. The method of claim 1, wherein said consumer response comprises a presence of a customer at said advertisers business.

4. A system for measuring the effectiveness of online advertising comprising:
a first networked server providing to at least one web page an online ad associated with an advertiser's web page, wherein said first networked server logs in a first database that said online ad is served to an ad-viewing user;
a display connected to a client computer presenting said at least one web page and said online ad to said ad-viewing user;
a second networked server identifying a visitor of said advertiser's web page, wherein said second network server identifies and logs in a second database said visitor of said advertiser's web page; and
a computer application program performing statistical analyses across said first database and said second database to determine whether said ad-viewing user is the same as said visitor, said computer application program analyzing data from the statistical analyses to provide a statistical measure of visitors of said advertiser's web page credited to said online ad.

5. The system of claim 4, wherein the computer application program performing statistical analyses comprises:
charting data relating to the time of an ad view event;
charting data relating to the time of a site-visit resulting from a direct click of the ad view event;
charting data relating to the time of a site-visit event resulting from a click delayed after the ad view event; and
charting data relating to the time of a site-visit event resulting for a click preceding the ad-view event.

6. The system of claim 4, wherein the computer application program performing statistical analyses comprises:
charting site-view sets of events for at least ad-viewing user;
charting an ad-view stream associated the site view set of events for said at least one ad-viewing user; [Huh? “associated the site view set . . . ”?]
banding ad view stream based upon a predetermined time; and
accumulating the site-view visits for said at least one ad-viewing user.

7. The system of claim 4, wherein said ad viewing user is a demographic control-group.

8. A system for measuring the effectiveness of advertising comprising:
a first networked server providing an ad associated with an advertiser at random times over a limited period of time, wherein said first networked server logs in a first database when said ad is served to an ad-viewer;
a display connected to a client computer presenting said ad to said ad-viewer; a second networked server measuring customer response after providing said ad and storing said customer response and a time of said customer response in a second database; and
a computer application program performing statistical analyses across said first database and said second database to determine the correlation of consumer response to the ad.

9. A computer-based method for measuring the effectiveness of advertising comprising:
presenting an ad associated with an advertiser to an ad-viewer at random times over a limited period of time;
providing an identification for said ad-viewing user; logging to a first log that said ad is served to said ad-viewer;
logging to a first log when said ad is served to said ad-viewer;
logging to a second log a customer response after providing said ad;
logging to a second log when said customer response occurs; and
performing statistical analyses between said first log and said second log to determine the correlation of consumer response to the ad.

10. The method of claim 9, wherein presenting an ad comprises presenting an online ad associated with an advertiser's webpage to an ad-viewing user.

11. The method of claim 10, further comprising:
providing an identification of a visitor to said advertiser's webpage;
performing cross-correlations between said first log and said second log to determine whether said ad-viewing iser s the same as said visitor; and
analyzing said cross-correlations to provide a statistical measure of visitors of said advertiser's webpage credited to said online ad.
